(19) United States
(12) Patent Application Publication
(10) Pub. No.: US 2026/0195191 A1
(43) Pub. Date: Jul. 9, 2026

(54) CONTAINER LAYER MANAGEMENT USING A CONTAINER PROCESS MAPPING IN A COMPUTING ENVIRONMENT

(71) Applicant: Red Hat, Inc., Raleigh, NC (US)

(72) Inventors: Leigh Griffin, Waterford (IE); Pierre-Yves Chibon, Puteaux (FR)

(73) Assignee: Red Hat, Inc., Raleigh, NC (US)

(21) Appl. No.: 19/014,142

(22) Filed: Jan. 8, 2025

(51) Int. Cl. G06F 9/50

(52) U.S. Cl. CPC G06F 9/5077

(57) ABSTRACT

A container process mapping can be used for container layer management in a computing environment. For example, a system can receive a mapping file indicating a mapping of one or more processes to one or more container layers of a container image. Each process can be mapped to a container layer in the mapping file. The system can determine, for an execution of a container associated with the container image, a first resource usage of each process of the one or more processes. The system can determine, based on the mapping file and the first resource usage, a second resource usage of each container layer of the one or more container layers. The system can perform, based on the second resource usage, an action for a container file that is executable to generate the one or more container layers.

### TECHNICAL FIELD

The present disclosure relates generally to software development. More specifically, but not by way of limitation, this disclosure relates to container layer management using a container process mapping in a computing environment.

### BACKGROUND

Software services such as applications, serverless functions, and microservices can be deployed inside containers within a computing environment. A container is a relatively isolated virtual computing environment created by leveraging the resource isolation features (e.g., cgroups and namespaces) of the Linux Kernel. Deploying software services inside containers can help isolate the software services from one another, which can improve speed and security and provide other benefits.

Containers are deployed from image files using a container engine, such as Docker or Podman. These image files are often referred to as container images. A container image can be conceptualized as a stacked arrangement of layers in which a base layer is positioned at the bottom and other layers are positioned above the base layer. The other layers may include a target software service and its dependencies, such as its libraries, binaries, and configuration files. The target software service may be configured to run (e.g., on a guest operating system) within the isolated context of the container.

### BRIEF DESCRIPTION OF THE DRAWINGS

FIG. 1 is a block diagram of an example of a computing environment for generating a container process mapping to container layers according to some examples of the present disclosure.

FIG. 2 is a block diagram of an example of a computing environment for container layer management using a container process mapping according to some examples of the present disclosure.

FIG. 3 is a block diagram of an example of a computing device for container layer management using a container process mapping according to some examples of the present disclosure.

FIG. 4 is a flowchart of a process for container layer management using a container process mapping in a computing environment according to some examples of the present disclosure.

### DETAILED DESCRIPTION

Containerized computing environments have become increasingly popular. For example, a containerized computing environment can use one or more containers to run software applications or processes in a relatively isolated virtual environment. Each container can include one or more container layers positioned in a stacked arrangement where each container layer can provide a respective functionality. The container layers can implement modularity with respect to managing and optimizing the software applications or the processes associated with the containers, which can facilitate resource management or resource allocation. A typical container management system overseeing the containers may provide functionality to identify running process of a particular container. But, a respective relationship between each running process and a corresponding container layer of the container is unknown, thereby limiting modifications to and monitoring of a container at a layer level. Additionally, a process may generate one or more child processes that can each generate one or more additional processes. Generational relationships between processes can make it difficult to determine which container layer initiated a particular process.

Some examples of the present disclosure can overcome one or more of the issues mentioned above by using a mapping of container processes to individual container layers to manage container development. A mapper service can generate the mapping to provide increased transparency regarding the individual container layers, which can facilitate container management and modularity. The mapper service may generate a mapping file that can indicate a respective mapping linking each process to the corresponding container layer. A container engine can receive the mapping file. For an execution of a container associated with the container image, the container image can determine a first resource usage of each process. Based on the mapping file and the first resource usage, the container image can determine a second resource usage of each container layer. The container engine can then perform an action for a container file that is executable to generate the one or more container layers. For example, the action may involve modifying the container file to include container layers associated with reduced resource consumption that perform a similar functionality as the original container layers. As such, resource consumption can be managed at a container-layer level, rather than just at a container level. So, whereas conventionally a container may become noncompliant and nonexecutable by consuming too many resources, the embodiments provide a technique for remaining compliant by reducing resource consumption.

In one particular example, an orchestration system of a containerized computing environment can execute a mapper service to generate a mapping file. The mapping file can indicate a respective relationship between each process of a container running in the containerized computing environment and a corresponding container layer of the container. For example, the mapping file can indicate that the container includes two container layers that each include two processes. As the container is executed, a container engine monitors the processes and determines that the first process of the first container layer consumes three Gigabytes of random access memory (RAM), the second process of the first container layer consumes two Gigabytes RAM, the first process of the second container layer consumes five Gigabytes of RAM, and the second process of the second container layer consumes one Gigabyte of RAM. So, the container engine can determine a resource usage for each container layer based on the resource usage by each process. That is, the container engine can determine that the first container layer uses five Gigabytes of RAM and the second container layer uses six Gigabytes of RAM. The container engine can evaluate container resource limits to determine whether the container is executable. For example, the container may have a resource limit of five Gigabytes of RAM per container layer. In some instances, the resource limit may be at the container level, specific for a particular container level (e.g., different between container levels), or specific for a particular process. Upon determining that the resource limit is five Gigabytes of RAM and that the second container layer exceeds the resource limit, the container engine can determine a different container layer that performs the same functionality as its two processes, but that consumes less than five Gigabytes of RAM. The container engine can then replace the second container layer with the other container layer and execute the container having the first container layer and the other container layer to consume fewer resources.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

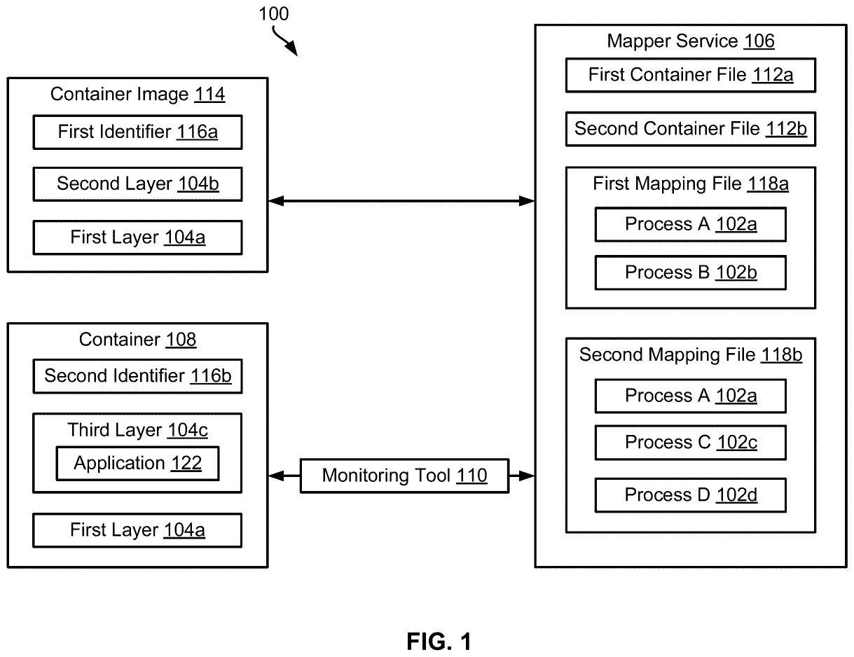

FIG. 1 is a block diagram of an example of a computing environment 100 for generating a container process mapping to container layers according to some examples of the present disclosure. In some examples, the computing environment 100 can be a distributed computing environment (e.g., a cloud computing environment, a computing cluster, etc.). Components within the computing environment 100 may be communicatively coupled, such as via a network (e.g., a local area network (LAN), wide area network (WAN), the Internet, etc.) or communication protocols. For example, the computing environment 100 can include a mapper service 106 that can monitor a container 108 in the computing environment 100 using a monitoring tool 110 (e.g., an extended Berkeley Packet Filter (eBPF)). The monitoring tool can include or run one or more programs within an operating system related to the container 108 to provide observability or monitoring functionality, such as to track resource consumption of the container 108 over time. In some implementations, the computing environment 100 can be hosted using one or more computing devices. Examples of a computing device can include a desktop computer, laptop computer, server, mobile phone, or tablet.

In some examples, the mapper service 106 can determine processes 102 to map to individual container layers 104 (e.g., first container layer 104a and second container layer 104b) of a container image 114. The mapper service 106 may use a container file to determine the processes that map to the individual container layers 104. The container file can be an executable file that can automate a process of creating the container image 114. The container image 114 can be a static, executable file that can include components, such as one or more files, libraries, dependencies, or metadata, used to build the container layers 104a-b. Once the container image 114 is executed (e.g., by a container engine), the container image 114 can be used to run a container that runs in the computing environment 100. For example, the container image 114 can contain suitable files to execute a particular operating system as part of the container. Executing the container image 114 can involve running one or more processes in an isolated portion of the computing environment 100 as part of the container. Each process generated using the container image 114 can be associated with a first container identifier 116a that can indicate which processes correspond to the container image 114.

As shown in FIG. 1, the container image 114 can include the first container layer 104a as a base layer and the second container layer 104b built on top of the first container layer 104a. As an example, the mapper service 106 can determine which processes of the container image 114 are introduced by the second container layer 104b, such as by examining an operating system of the container image 114. The mapper service 106 can compare a list of processes running in the operating system after building the first container layer 104a with an updated list of processes running after building the second container layer 104b. The mapper service 106 can assign any new processes in the updated list of processes to the second container layer 104b. Based on building the container layers 104a-b, the mapper service 106 can generate a mapping file 118 linking each process of the processes 102a-b to a respective container layer (e.g., the first container layer 104a or the second container layer 104b).

As an example, after the first container layer 104a is built, the mapper service 106 can determine that process A 102a is running as part of the operating system. The mapper service 106 then can map process A 102a to the first container layer 104a. As another example, after the first container layer 104a and the second container layer 104b are built, the mapper service 106 can determine that both process A 102a and process B 102b are running. Consequently, the mapper service 106 can determine that process B 102b is a new process introduced by building the second container layer 104b. Accordingly, the mapper service 106 can assign process B 102b to the second container layer 104b. In other words, a list of existing processes can be compared with an updated list of processes determined after each container layer of the container image 114 is generated to determine whether the updated list of processes includes one or more new processes. The mapper service 106 can attribute, assign, map, or otherwise associate the new processes with the container layer associated with the updated list of processes.

Additionally or alternatively, in some examples, the mapper service 106 can map one or more container processes of a container 108 that is currently running in the computing environment 100 to container layers 104 of the container 108. As shown in FIG. 1, the container 108 can include the first container layer 104a and a third container layer 104c built on the first container layer 104a. Other arrangements or amounts of container layers are possible. Each container layer may generate at least one process 102. The container 108 can include a collection of processes (e.g., process A 102a, process C 102c, and process D 102d) initiated in the computing environment 100 based on a container image. Each process associated with the container 108 can include a container identifier, such as a second container identifier 116b, corresponding to the container 108. The mapper service 106 can determine which processes in the computing environment 100 are associated with the container 108 based on the second container identifier 116b. In some examples, the container 108 shown in FIG. 1 can be different from a container generated using the container image 114. For example, the container 108 and the container image 114 include different container layers.

In some implementations, the mapper service 106 can use the monitoring tool 110 (e.g., an extended Berkeley Packet Filter (eBPF)) to monitor the processes 102 of the container 108, such as while the processes 102 are running in the computing environment 100. The monitoring tool 110 can collect monitoring data related to the processes 102, such as with respect to resource consumption, computational costs, energy costs, or a combination thereof. For example, the monitoring data can indicate a respective resource consumption of the processes 102, such as with respect to processing power, memory, storage, etc. In some examples, the monitoring tool 110 can include one or more software programs that are run based on an event that occurs. Examples of the event can include system calls, network events, kernel tracepoints, etc. As an example, the monitoring tool 110 can include tracing programs that can be attached to specific functions in a kernel used by the container 108. The tracing programs can collect information related to the specific functions, such as data that the specific functions are processing or system resources (e.g., storage, processing power, etc.) consumed by the specific functions.

Using the monitoring tool 110, the mapper service 106 can identify one or more software applications or one or more commands included in a container file related to the container 108, such as a second container file 112b. The mapper service 106 can analyze the information collected by the monitoring tool 110 to determine which software application or command initiated a corresponding process. Determining a relationship between a process and a specific container layer can involve determining that the process is related to a software application generated by the specific container layer.

In some examples, the mapper service 106 can implement pattern matching to compare information, such as metadata, related to a particular process with the software applications or the commands to determine a respective mapping between each process and a respective container layer of the container 108. Additionally or alternatively, the mapper service 106 can analyze a specification file of a software application 122 to assign processes of the container 108 to individual container layers. In some cases, the specification file can include information related to the software application 122, such as system resources, configurations, etc. Additionally, the specification file can indicate which processes are instantiated by the software application 122. Based on the specification file, the mapper service 106 can link the processes instantiated by the software application 122 to a particular container layer (e.g., the third container layer 104c) of the container 108 that relates to the software application 122. In some examples, the specification file may indicate that the software application 122 can generate or initiate one or more additional applications. Based on the specification file, the mapper service 106 can link each process associated with the additional applications to the software application 122 and to a corresponding container layer (e.g., the third container layer 104c).

Once the mapper service 106 determines a respective relationship between each process of the container 108 and a corresponding container layer of the container 108, the mapper service 106 can generate a mapping file, such as a second mapping file 118b. The second mapping file 118b can include a respective mapping that links process A 102a, process C 102c, and process D 102d to the corresponding container layer (e.g., the first container layer 104a or the third container layer 104c). In some cases, more than one process can be assigned to the same container layer. For example, process C 102c and process D 102d may both be assigned to the third container layer 104c.

While FIG. 1 depicts a specific arrangement of components, other examples can include more components, fewer components, different components, or a different arrangement of the components shown in FIG. 1. For example, in other implementations, the container 108 or the container image 114 may include a different number of container layers. As another example, in other implementations, the computing environment 100 may include a container engine that can execute the mapper service 106. Additionally, any component or combination of components depicted in FIG. 1 can be used to implement the process(es) described herein.

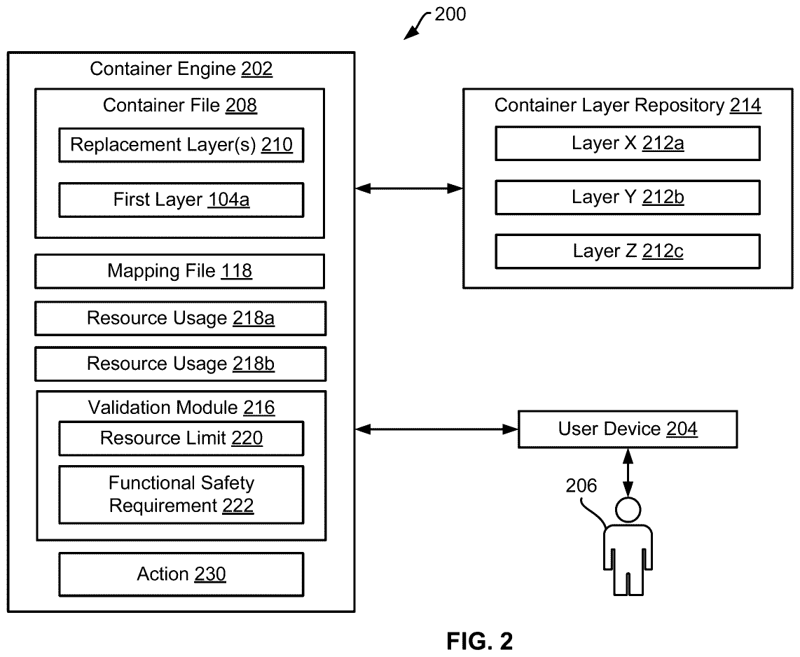

FIG. 2 is a block diagram of another example of a computing environment 200 for container layer management using a container process mapping according to some examples of the present disclosure. In some examples, components shown in FIG. 2 can be part of the computing environment 100 of FIG. 1. Certain aspects of FIG. 2 are described below with reference to components of FIG. 1.

As shown, the computing environment 200 can include a container engine 202 (e.g., Docker, Podman, etc.) that can facilitate container deployment, such as building or running one or more containers. Additionally or alternatively, the container engine 202 may be part of or in communication with an container orchestration system that can facilitate container management, such as with respect to managing or scheduling a lifecycle of the containers, etc. As an example, the container engine 202 may receive user input from a user device 204 to modify the computing environment 200, such as by running a particular container. The user input can be generated by a user 206 interacting with the user device 204, such as via an input device (e.g., a mouse, a touchscreen, a keyboard, etc.).

In some examples, the container engine 202 can receive the mapping file 118 generated in FIG. 1 that indicates a mapping between processes and container layers of a container image. In the mapping file 118, each process involved in executing a container from the container image is mapped to a container layer. When the container engine 202 executes the container image, the container engine 202 can determine a resource usage 218a associated with each process. For instance, the resource usage 218a may include one or more of a central processing unit, a memory, a disk input/output (I/O), a network I/O, and the like that is consumed by a process during execution of a container associated with the container image. The container engine 202 can monitor the execution of the container to determine the resource usage 218a for each process.

In some examples, upon determining the resource usage 218a for each process, the container engine 202 can use the mapping file 118 to determine a resource usage 218b of each container layer of the container. The resource usage 218b for each container layer can be the aggregate of the resource usage 218a for each process associated with the container layer. For example, the mapping file 218 can indicate that the first container layer 104 is associated with a first process and a second process. In addition, the resource usage 218a can indicate that the first process consumes four Gigabytes of random access memory (RAM) and that the second process consumes two Gigabytes of RAM. So, the container engine 202 can determine that the resource usage 218b for the first container layer 104a is six Gigabytes of RAM.

The container engine 202 can then perform an action 230 for the container file 208 based on the resource usage 218b for the container layers. For example, a validation module 216 of the container engine 202 may determine whether the action 230 is to involve updating the container file 208 to include one or more replacement container layer(s) 210 based on the resource usage 218b. The one or more replacement container layers 210 can be used to replace a noncompliant container layer. For example, the container file 208 may be an updated version of the first container file 112a or the second container file 112b of FIG. 1. As shown, the container file 208 includes a first container layer 104a and the replacement container layer(s) 210, where the first container layer 104a was previously provided in the first container file 112a and the second container file 112b. Other implementations are possible. For example, the noncompliant container layer that is replaced may be positioned between two compliant container layers previously included in a container file. As another example, the noncompliant container layer can be a base layer or a first layer of a container file.

In some cases, the replacement container layer(s) 210 can be selected from one or more equivalent container layers 212 that can be stored in a container layer repository 214 accessible by the container engine 202. As shown in FIG. 2, the container layer repository 214 includes a first equivalent container layer X 212a, a second equivalent container layer Y 212b, and a third equivalent container layer Z 212c. Other quantities or configurations are possible. In some examples, the equivalent container layers 212 may provide similar or the same functionality. In other examples, each equivalent container layer may provide a different functionality that is equivalent to (e.g., similar to or the same as) another container layer included in a particular container file, a particular container image, or a particular container.

The container engine 202 can retrieve a subset of the equivalent container layers 212 from the container layer repository 214 as the replacement container layer(s) 210 to generate the container file 208. In some examples, the container engine 202 can have a respective set of layer options associated with each functionality. For example, a table that identifies which container layers are functionally equivalent (e.g., have the same or similar functionality) can be provided to or otherwise accessible by the container engine 202. As another example, the equivalent container layers 212 stored in the container layer repository 214 can have annotations to tag which container layers are functionally equivalent. The container engine 202 can use the table or the annotations to select the replacement container layer(s) 210 to swap with the noncompliant container layer to generate the updated container file 208. Generating the updated container file 208 can involve replacing the noncompliant container layer with the replacement container layer(s) 210 and rebuilding each container layer positioned subsequent to the noncompliant container layer.

In some examples, artificial intelligence or machine-learning can be implemented to select or assist with selecting the replacement container layer(s) 210. For example, a machine-learning model can be trained using training data to generate an output that can provide a recommendation related to the replacement container layer(s). The training data can include historical data corresponding to previous replacements made to generate historical updated container files. In some cases, the training data can relate to different scenarios for which replacing a container layer would occur. Examples of the different scenarios are further described herein. For example, a subset of the training data can relate to swapping out a container layer that is noncompliant with a functional safety standard. The subset of the training data can include labeled training inputs and labeled training outputs such that the machine-learning model can learn to output a recommendation indicating a replacement container layer 210 that is compliant with the functional safety standard. As another example, a subset of the training data can relate to replacing a container layer that is noncompliant with resource usage limits associated with container layers. Accordingly, the machine-learning model may be trained to determine a reason to replace the container layer and use the reason to generate or tailor its recommendation.

In some implementations, determining whether to update the container file 208 can involve the validation module 216 determining that the resource usage 218b for a container layer exceeds a resource limit 220. For example, the resource usage 218b for a container layer (e.g., the second container layer 104b of the second container file 112b in FIG. 1) may be three CPU cores, but the resource limit 220 for the container layer may be two CPU cores. As a result, the validation module 216 can determine that the container layer 104b is noncompliant. So, the validation module 216 can determine an equivalent container layer 212 in the container layer repository 214 that is associated with a similar functionality as the container layer 104b and that has a resource usage that is below the resource limit 220. The resource usage for the container layers 212 can be indicated in metadata associated with the equivalent container layers 212. For example, equivalent container layer X 212a may have a similar functionality and a resource usage of two CPU cores. So, in this case, the action 230 can involve the container engine 202 replacing the container layer 104b with the container layer X 212a in the container file 208. So, the replacement container layers 210 correspond to the container layer X 212a. The container engine 202 can execute the container file 208 to generate an updated container that is compliant with the resource limit 220.

In some examples, the resource limit 220 may correspond to a resource availability for the container layer. So, upon determining that the resource usage 218b for a container layer exceeds the resource limit 220, the container engine 202 can perform the action 230 of increasing the resource availability by adding resources to the container layer. For example, the resource availability for the first container layer 104a may be five Gigabytes of RAM. Upon determining that the resource usage 218b of six Gigabytes of RAM by the first container layer 104a exceeds the resource availability, the container engine 202 can horizontally scale the first container layer 104a by adding at least one Gigabyte of RAM for the first container layer 104a. In this way, resources are only added the container layers that need the resources, and not to the container as a whole.

In some examples, the container engine 202 can execute the validation module 216 to determine whether any processes in the container file are noncompliant with a functional safety requirement 222. Functional safety relates to reducing risks so that computing components function safely in an event of a malfunction. The functional safety requirement can correspond to a functional safety standard that can correspond to a target level of risk reduction to minimize a likelihood of hazardous operational situations. Software deployed in containers can be certified to a particular functional safety standard based on meeting or exceeding the functional safety requirement(s) 222 of the particular functional safety standard. Functional safety analysis typically involves determining functional safety compliance at a container level, such as by determining that the container is overall compliant with the functional safety requirement 222. But, individual container layers of a compliant container may not necessarily be compliant with the functional safety requirement 222.

The validation module 216 can determine that a particular container layer of the container file is noncompliant with the functional safety requirement 222. For example, referring to aspects of FIG. 1, the validation module 216 may determine that the second container layer 104b of the first container file 112a is noncompliant with the functional safety requirement 222. Based on the particular container layer being noncompliant, the container engine 202 can select a compliant container layer from the equivalent container layers 212 as the replacement container layer 210 to generate the updated container file 208. In particular, the compliant container layer can be compliant with the functional safety requirement 222 while providing similar or the same functionality as the noncompliant container layer that is being replaced with the compliant container layer. Once the container engine 202 obtains the compliant container layer, the container engine 202 can update the container file to generate the container file 208 that replaces the noncompliant container layer with the compliant container layer. The container engine 202 can execute the container file 208 to generate an updated container that is compliant with the functional safety requirement 222.

In some implementations, a problematic container layer (e.g., a noncompliant container layer) can be replaced with more than one container layer. For example, the problematic container layer can be a container layer that is overloaded, such as due to the container layer being configured to generate a number of processes that exceeds a predefined threshold or due to the container layer being configured to consume resources exceeding the resource limit 220. In particular, the container layer being configured to generate a relatively large number of processes can be indicative of a compromised container layer that can execute a distributed denial-of-service (DDoS) attack. The processes generated by the compromised container layer can overwhelm one or more components of the computing environment 200, such as a machine hosting a container with the compromised container layer. More specifically, resource consumption of the processes can prevent other processes in the computing environment 200 from accessing sufficient system resources to function properly. Consequently, the other processes may be unable to provide certain services or functionality, such as to maintain a secure computing environment or to communicate with hardware devices.

The container engine 202 can identify an overloaded container layer using a container file associated with the overloaded container layer. For example, the container engine 202 can determine the number of processes associated with the overloaded container layer and compare the number of processes to the predefined threshold. Based on the number of processes exceeding the predefined threshold, the container engine 202 can identify the overloaded container layer. Once the overloaded container layer is identified, the container engine 202 may disallow the overloaded container layer, such as to prevent resource exhaustion. Disallowing the overloaded container layer can include removing the overloaded container layer from the container file 208 or otherwise deactivating the overloaded container layer.

In some examples, the based on the resource usage 218b by a container layer exceeding the resource limit 220, the container engine 202 can identify the overloaded container layer. Once the overloaded container layer is identified, the container engine 202 may determine whether the processes associated with the container layer are optional for execution of the container. For example, the container layer may be associated with the process D 102d, which is optional for executing the container file. As a result, the container engine 202 can perform the action 230 of removing the container layer from the container file 208 or otherwise deactivating the overloaded container layer.

Additionally or alternatively, the container engine 202 can select a set of container layers to replace the overloaded container layer. For example, the overloaded container layer can be broken down to generate the set of container layers to replace the overloaded container layer. As an example, if the updated container file 208 is an updated version of the first container file 112a of FIG. 1, the updated container file 208 can include a set of replacement container layers 210 to replace the second container layer 104b. For instance, the second container layer 104b may be associated with process A 102a and process C 102c. So, the container engine 202 can perform the action 230 of generating a set of replacement container layers 210 that include a first replacement container layer associated with the process A 102a and a second replacement container layer associated with the process C 102c. The resource usage for each of the first replacement container layer and the second replacement container layer can be below the resource limit 220.

In some examples, the set of replacement container layers 210 can include any container layer stored in the container layer repository 214 or any suitable combination thereof. For example, the overloaded container layer can provide a particular set of functionalities, which can include a validation functionality and a logging functionality. The overloaded container layer can be split into a respective subset of replacement container layers 210 related to each functionality in the particular set of functionalities. In particular, the overloaded container layer can be replaced with a subset of replacement container layers 210 providing the validation functionality and another subset of replacement container layers 210 providing the logging functionality.

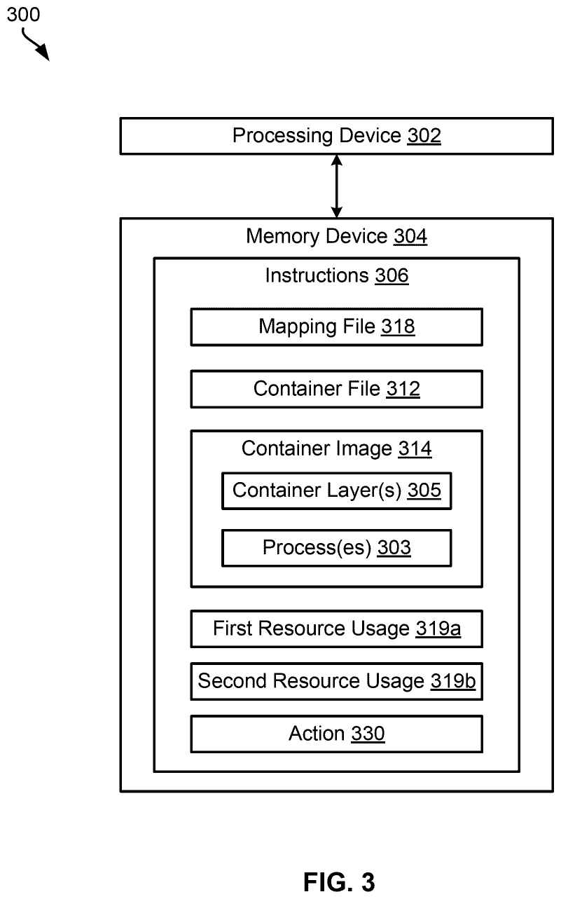

FIG. 3 is a block diagram of an example of a computing device for container layer management using a container process mapping according to some examples of the present disclosure. The computing device 300 can include a processing device 302 communicatively coupled to a memory device 304.

The processing device 302 can include one processing device or multiple processing devices. The processing device 302 can be referred to as a processor. Non-limiting examples of the processing device 302 include a Field-Programmable Gate Array (FPGA), an application-specific integrated circuit (ASIC), and a microprocessor. The processing device 302 can execute instructions 306 stored in the memory device 304 to perform operations. In some examples, the instructions 306 can include processor-specific instructions generated by a compiler or an interpreter from code written in any suitable computer-programming language, such as C, C++, C #, Java, Python, or any combination of these.

The memory device 304 can include one memory device or multiple memory devices. The memory device 304 can be non-volatile and may include any type of memory device that retains stored information when powered off. Non-limiting examples of the memory device 304 include electrically erasable and programmable read-only memory (EEPROM), flash memory, or any other type of non-volatile memory. At least some of the memory device 304 includes a non-transitory computer-readable medium from which the processing device 302 can read instructions 306. A computer-readable medium can include electronic, optical, magnetic, or other storage devices capable of providing the processing device 302 with the instructions 306 or other program code. Non-limiting examples of a computer-readable medium include magnetic disk(s), memory chip(s), ROM, random-access memory (RAM), an ASIC, a configured processor, and optical storage.

In some examples, the processing device 302 can execute the instructions 306 to perform operations. For example, the processing device 302 can receive a mapping file 318 indicating a mapping of one or more processes 303 to one or more container layers 305 of a container image 314. Each process of the one or more processes 303 can be mapped to a container layer of the one or more container layers 305 in the mapping file 318. The processing device 302 can determine, for an execution of a container associated with the container image 314, a first resource usage 319a of each process of the one or more processes 303. The processing device 302 can determine, based on the mapping file 318 and the first resource usage 319a, a second resource usage 319b of each container layer of the one or more container layers 305. The processing device 302 can perform, based on the second resource usage 319b, an action 330 for a container file 312 that is executable to generate the one or more container layers 305 of the container image 314. The action 330 may involve replacing container layers that disproportionately consume resources with container layers that perform similar functionality but consume less resources. Or, the action 330 may involve decomposing container layers associated with multiple processes into a single container layer per process, where each container layer is associated with a resource limit. Having a container layer per process can ensure that resources are efficiently consumed at the process level through the container level, since there can be a resource limit associated with each level.

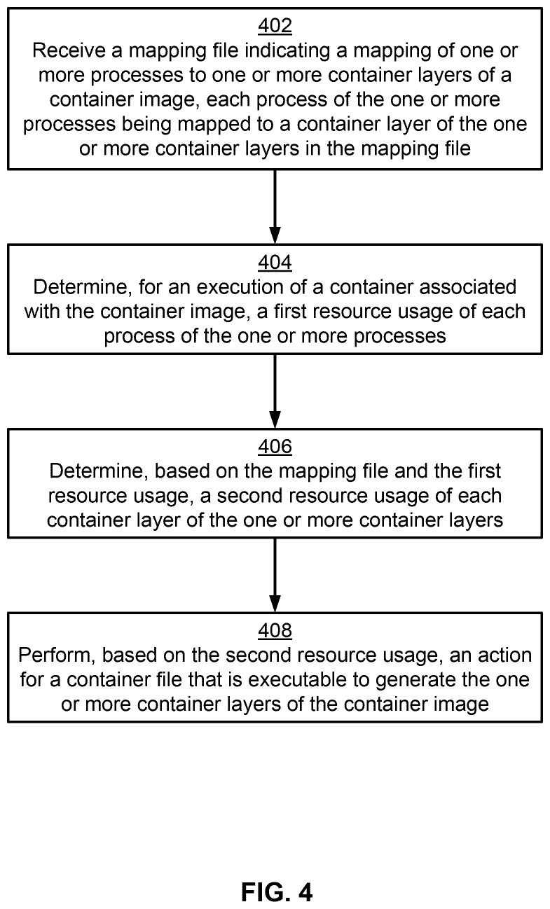

FIG. 4 is a flowchart of a process for container layer management using a container process mapping in a computing environment (e.g., the computing environment 100 of FIG. 1) according to some examples of the present disclosure. In some examples, the processing device 302 can perform one or more of the steps shown in FIG. 4. In other examples, the processing device 302 can implement more steps, fewer steps, different steps, or a different order of the steps depicted in FIG. 4. The steps of FIG. 4 are described below with reference to components discussed above in FIGS. 1-3.

In block 402, the processing device 302 can receive a mapping file 318 indicating a mapping of one or more processes 303 to one or more container layers 305 of a container image 314. Each process of the one or more processes 303 can be mapped to a container layer of the one or more container layers 305 in the mapping file 318. To determine the mapping, each process of the one or more processes 303 can be generated by a respective container layer of a container file 312. In some examples, the processing device 302 can determine the processes 303 by building each container layer, such as using the container file 312. More specifically, by discretely building each container layer, the processing device 302 can narrow down a respective subset of the processes 303 corresponding to each container layer. For example, subsequent to building a first container layer, the processing device 302 can determine a difference in processes that are currently available compared to processes that were previously available before building the first container layer. The respective subset of the processes 303 corresponding to the first container layer can be determined based on the difference.

In other examples, the processing device 302 can determine the mapping while the processes 303 are running or being executed. For example, the processing device 302 can execute the container image 314 to generate a container as a running instance of the container image 314. Generating the container can involve implementing or initiating the processes 303 that are part of the container layers 305 of the container image 314. In particular, each process initiated based on the container image 314 or the container file 312 can be identifiable using a container identifier. Accordingly, the processing device 302 can search for the container identifier to determine the processes 303 associated with the container image 314 or the container file 312.

In block 404, the processing device 302 can determine, for an execution of a container associated with the container image 314, a first resource usage 319a of each process of the one or more processes 303. As the container is executed, the processing device 302 can monitor the execution and the resources consumed by each process. As such, the processing device 302 can determine the first resource usage 319a for each of the processes 303.

In block 406, the processing device 302 can determine, based on the mapping file 318 and the first resource usage 319a, a second resource usage 319b of each container layer of the one or more container layers 305. The processing device 302 can aggregate the first resource usage 319a for each of the processes 303 associated with a container layer to determine the second resource usage 319b for the container layer. The second resource usage 319b can correspond to a memory usage, a network I/O usage, a disk I/O usage, a CPU usage, or a combination thereof for each of the container layers 305.

In block 408, the processing device 302 perform, based on the second resource usage 319b, an action 330 for a container file 312 that is executable to generate the one or more container layers 305 of the container image 314. The action 330 can involve replacing a container layer of the container layers 305 with a different container layer if the processing device 302 determines that the second resource usage 319b for the original container layer exceeds a resource limit. Or, the action 330 may involve horizontally scaling resources for a container layer for which its second resource usage 319b exceeds a resource limit. As another example, the action 330 may involve generating individual container layers for each process involved in a container layer of the container layers 305 so that each container layer can have a resource usage below a resource limit. Other actions are also possible, such as removing a container layer from the container layers 305 that is optional for the execution of the container.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations comprising:
receiving a mapping file indicating a mapping of one or more processes to one or more container layers of a container image, each process of the one or more processes being mapped to a container layer of the one or more container layers in the mapping file;
determining, for an execution of a container associated with the container image, a first resource usage of each process of the one or more processes;
determining, based on the mapping file and the first resource usage, a second resource usage of each container layer of the one or more container layers; and
performing, based on the second resource usage, an action for a container file that is executable to generate the one or more container layers of the container image.

2. The system of claim 1, wherein the operations further comprise:
determining that the second resource usage for a first container layer of the one or more container layers exceeds a resource limit;
determining that a second container layer associated with a similar functionality as the first container layer has a third resource usage that is below the resource limit; and
performing the action by replacing the first container layer with the second container layer in the container file.

3. The system of claim 1, wherein the operations further comprise:
determining that the second resource usage for a first container layer of the one or more container layers exceeds a resource availability; and
performing the action by increasing the resource availability by adding resources to the first container layer.

4. The system of claim 1, wherein the operations further comprise:
determining that the second resource usage for a first container layer of the one or more container layers exceeds a resource limit, wherein the first container layer is associated with a first process of the one or more processes and a second process of the one or more processes; and
in response to determining that the second resource usage exceeds the resource limit, performing the action by generating a second container layer that is associated with the first process and a third container layer for the second process, wherein a third resource usage for the second container layer and a fourth resource usage for the third container layer are each below the resource limit.

5. The system of claim 1, wherein the operations further comprise:
determining that the second resource usage for a first container layer of the one or more container layers exceeds a resource limit, wherein the first container layer is associated with a first process of the one or more processes;
determining that the first process is optional for executing the container file; and
in response to determining that the second resource usage exceeds the resource limit and that the first process is optional, performing the action by removing the first container layer from the container file.

6. The system of claim 1, wherein the operations further comprise:
determining that a particular container layer of the one or more container layers is noncompliant with a functional safety requirement;
in response to determining that the particular container layer is noncompliant with the functional safety requirement, selecting a compliant container layer that is compliant with the functional safety requirement from a set of equivalent container layers providing similar functionality as the noncompliant container layer; and
updating the container file to replace the noncompliant container layer with the compliant container layer.

7. The system of claim 1, wherein the operations further comprise:
determining that a particular container layer of the one or more container layers is overloaded based on the particular container layer being configured to generate a number of processes that exceeds a predefined threshold;
selecting a set of container layers to replace the particular container layer, wherein each container layer in the set of container layers is configured to generate a respective subset of the processes configured to be generated by the particular container layer; and
updating the container file to replace the particular container layer with the set of container layers.

8. A method comprising:
receiving a mapping file indicating a mapping of one or more processes to one or more container layers of a container image, each process of the one or more processes being mapped to a container layer of the one or more container layers in the mapping file;
determining, for an execution of a container associated with the container image, a first resource usage of each process of the one or more processes;
determining, based on the mapping file and the first resource usage, a second resource usage of each container layer of the one or more container layers; and
performing, based on the second resource usage, an action for a container file that is executable to generate the one or more container layers of the container image.

9. The method of claim 8, further comprising:
determining that the second resource usage for a first container layer of the one or more container layers exceeds a resource limit;
determining that a second container layer associated with a similar functionality as the first container layer has a third resource usage that is below the resource limit; and
performing the action by replacing the first container layer with the second container layer in the container file.

10. The method of claim 8, further comprising:
determining that the second resource usage for a first container layer of the one or more container layers exceeds a resource availability; and
performing the action by increasing the resource availability by adding resources to the first container layer.

11. The method of claim 8, further comprising:
determining that the second resource usage for a first container layer of the one or more container layers exceeds a resource limit, wherein the first container layer is associated with a first process of the one or more processes and a second process of the one or more processes; and
in response to determining that the second resource usage exceeds the resource limit, performing the action by generating a second container layer that is associated with the first process and a third container layer for the second process, wherein a third resource usage for the second container layer and a fourth resource usage for the third container layer are each below the resource limit.

12. The method of claim 8, further comprising:
determining that the second resource usage for a first container layer of the one or more container layers exceeds a resource limit, wherein the first container layer is associated with a first process of the one or more processes;
determining that the first process is optional for executing the container file; and
in response to determining that the second resource usage exceeds the resource limit and that the first process is optional, performing the action by removing the first container layer from the container file.

13. The method of claim 8, further comprising:
determining that a particular container layer of the one or more container layers is noncompliant with a functional safety requirement;
in response to determining that the particular container layer is noncompliant with the functional safety requirement, selecting a compliant container layer that is compliant with the functional safety requirement from a set of equivalent container layers providing similar functionality as the noncompliant container layer; and
updating the container file to replace the noncompliant container layer with the compliant container layer.

14. The method of claim 8, further comprising:
determining that a particular container layer of the one or more container layers is overloaded based on the particular container layer being configured to generate a number of processes that exceeds a predefined threshold;
selecting a set of container layers to replace the particular container layer, wherein each container layer in the set of container layers is configured to generate a respective subset of the processes configured to be generated by the particular container layer; and
updating the container file to replace the particular container layer with the set of container layers.

15. A non-transitory computer-readable medium comprising program code executable by a processing device for causing the processing device to perform operations comprising:
receiving a mapping file indicating a mapping of one or more processes to one or more container layers of a container image, each process of the one or more processes being mapped to a container layer of the one or more container layers in the mapping file;
determining, for an execution of a container associated with the container image, a first resource usage of each process of the one or more processes;
determining, based on the mapping file and the first resource usage, a second resource usage of each container layer of the one or more container layers; and
performing, based on the second resource usage, an action for a container file that is executable to generate the one or more container layers of the container image.

16. The non-transitory computer-readable medium of claim 15, wherein the operations further comprise:
determining that the second resource usage for a first container layer of the one or more container layers exceeds a resource limit;
determining that a second container layer associated with a similar functionality as the first container layer has a third resource usage that is below the resource limit; and
performing the action by replacing the first container layer with the second container layer in the container image.

17. The non-transitory computer-readable medium of claim 15, wherein the operations further comprise:
determining that the second resource usage for a first container layer of the one or more container layers exceeds a resource availability; and
performing the action by increasing the resource availability by adding resources to the first container layer.

18. The non-transitory computer-readable medium of claim 15, wherein the operations further comprise:
determining that the second resource usage for a first container layer of the one or more container layers exceeds a resource limit, wherein the first container layer is associated with a first process of the one or more processes and a second process of the one or more processes; and
in response to determining that the second resource usage exceeds the resource limit, performing the action by generating a second container layer that is associated with the first process and a third container layer for the second process, wherein a third resource usage for the second container layer and a fourth resource usage for the third container layer are each below the resource limit.

19. The non-transitory computer-readable medium of claim 15, wherein the operations further comprise:
determining that the second resource usage for a first container layer of the one or more container layers exceeds a resource limit, wherein the first container layer is associated with a first process of the one or more processes;
determining that the first process is optional for executing the container file; and
in response to determining that the second resource usage exceeds the resource limit and that the first process is optional, performing the action by removing the first container layer from the container file.

20. The non-transitory computer-readable medium of claim 15, wherein the operations further comprise:
determining that a particular container layer of the one or more container layers is noncompliant with a functional safety requirement;
in response to determining that the particular container layer is noncompliant with the functional safety requirement, selecting a compliant container layer that is compliant with the functional safety requirement from a set of equivalent container layers providing similar functionality as the noncompliant container layer; and
updating the container file to replace the noncompliant container layer with the compliant container layer.
